(19) United States
(12) Patent Application Publication
(10) Pub. No.: US 2011/0196065 A1
(43) Pub. Date: Aug. 11, 2011

(54) COATING, METHOD OF APPLYING THE COATING AND USE THEREOF

(76) Inventors: Kurt-Michael NOACK, Stolzenau (DE); Cong Minh Nguyen, Stolzenau (DE)

(21) Appl. No.: 13/024,411

(22) Filed: Feb. 10, 2011

(30) Foreign Application Priority Data
Feb. 10, 2010 (DE) 102010007672.4-43

(51) Int. Cl. C09D 127/06; C09D 131/04; C08K 7/16

(52) U.S. Cl. 523/223; 524/527; 524/524

(57) ABSTRACT

The present invention relates to a coating for application to a substrate, comprising: high-molecular-weight, substantially ungelled polyvinyl chloride (PVC) with a K-value of more than 90, a matrix of a substantially gelled PVC material with a K-value of 60 to 80 and/or a gelled vinyl acetate/PVC copolymer with a K-value of 50 to 70, and at least one polymeric plasticiser; and also a method of applying such a coating, and uses thereof.

The present invention relates to a coating especially for application to a substrate for the production of automobile interior materials, a method of applying such a coating, and its use.

PVC materials have long been used in car interiors, e.g. as a material for blinds, for luggage compartment covers, roller blinds for sun protection for roof, rear and side windows and windscreens. It is also known to use these materials as lamination films or artificial leather.

So far, the only materials used for these applications in the automotive sector have been ones that are painted on the PVC surfaces. That has been necessary so far because the plasticisers contained migrate via the surface into adjacent contact materials. When unpainted surfaces are stored in contact with one another, subject to pressure and temperature loads, such as those which result when they are used in normal roller blind materials, diffusion bridges occur which, even after only a short time, can cause intensive adhesive bonds that may even be in-dissoluble in extreme cases. This critical migration is prevented by effective layers of paint, which form a diffusion barrier. In the description found in testing technology, the term used for the adhesion of similar or identical PVC surfaces is “caking”. Tests describe, for example, contact storage of two PVC material surfaces with a surface area of 50×50 mm under a load of 50N at temperatures of 70, 90 or 100° C. for a period of 24h or longer.

In addition, the painting makes a major contribution to the wear resistance of the material under normal conditions of use. These include, inter alia, abrasion and scratch resistance, media resistance to detergents or solvents, and stain resistance.

In addition to providing the basic technical functions listed, the paint layer also shapes the visual and haptic perception. The very matt surface usually found in car interior materials can only be created on the typically glossy PVC surfaces by using heavily matted paints. The provision of these varied functions by means of paints also results in extensive problems, however.

First of all, the painting requires an additional process step, which has a negative effect on the energy balance because of the drying process. The solvents contained in paint result in emissions in the production process, and some residual amounts are left in the material itself.

These residual amounts incorporated in this way are for their part the source of emissions in use, which may be perceived in the form of the critical problem of fogging or even a distinct odour. These emissions occur above all in the case of solvent-based paints, but also arise from the cosolvents in water-based paints. The paint polymers used must be compatible with the PVC applied and develop good adhesion. The usual deformations which occur when the material is in use or during the usual further processing steps must not lead to any destruction of the paint layer.

In addition, the matting agent required, which is usually present in large quantities, also results in an impairment of the mechanical strength.

If the material is stretched during processing, critical phenomena such as glossing can arise in substrate-free films in the deep-drawing process even if there is no destruction.

The typical process for applying the paint to the materials described—coating with coating rolls—places considerable demands on the leveling capacity of the paints; even with the optimum design, inhomogeneous layers with typical accumulations of material cannot be reliably avoided; they are visible in the form of unattractive grid-like structures.

These surface disturbances contain weak points with regard to the mechanical strength and chemical resistance and, in combination with graining introduced subsequently, may generate moiré structures.

Furthermore, the systems used often require a high degree of crosslinking, so that they retain little of the largely thermoplastic behaviour of the PVC material which is usually indispensable for the standard further processing steps. This results in impairments during embossing or in thermoplastic or high-frequency welding.

The desired, particularly homogeneous and dense layer of paint may also prove disadvantageous for the usual subsequent processing step of embossing, since it hinders the diffusion of the trapped air, which expands with the rapid heating. Pits from burst blisters or channels which are visible under a microscope are the typical error symptoms in this connection.

When combined with thick PVC coats, this risk is aggravated considerably, so that it is then unavoidable for them to be divided into two coats.

Precisely this, however, is extremely energy-intensive, because the flat sheet structure has to be cooled to room temperature between the two coating steps and then raised back to the gelling temperature after the subsequent coat has been applied.

Moreover, in order to produce a multi-layer sheet structure of this kind with the standard in-line coating systems, very expensive multi-channel arrangements are required, which take up a great deal of space.

In many cases, it is necessary to apply a layer of paint for the process, because it provides the requisite surface stability and gliding properties for the passage of the doctor blade arrangement when coating the back (inter alia with the supporting air blade arrangement which is critical for this purpose).

A general impairment of the material, especially with substrate-free films, arises when the paint is applied in roll-coating lines, because of the normal tensile stresses, which lead to elongation and a loss of width at the drying temperatures, which in turn can result in undesirable shrinkage phenomena during further processing.

In addition, it is known that particularly thick and highly matted layers of paint have limitations in transparency and appear dull on the surface, which can considerably impair the perception of colour. Counter-measures adopted involve increasing the pigment content which is usually expensive, though an inconsistent colour remains, depending very much on the paint film formed. Changes to the paint films because of stretching or embossing can cause distinct differences in the two-dimensional appearance.

Clear or intensive colours may sometimes be ruled out completely with paint designs of this kind.

In some cases, problems also arise from the fact that, in very complex composite systems, e.g. with polyurethane foams, as the plasticisers migrate via the PVC base material, incompatible substances diffuse to the paint polymers, which trigger rearrangement or degradation reactions there. Polyurethane paints, which are otherwise basically advantageous, react particularly sensitively in this connection to amines, which are contained in the polyurethane foams. In order to prevent this, special stabilisation measures may be required, and in extreme cases, it may be necessary to apply diffusion-tight barrier layers.

Another major disadvantage with painting is that when fabric substrates are used, a considerable amount of paste is required simply in order to level out the surface sufficiently for a normal, even paint application with coating rolls.

In view of the fact that the paint layer can only be provided thinly (well below 10 μm), the wide range of requirements described results in a system that is subject to great stress, with a high risk of failure.

A further disadvantage of a paint layer is that if it is impaired, the damage can be detected visually at once, which makes the entire coating, including the layer of paint, appear inferior.

It is an object of the present invention to provide a coating which overcomes the disadvantages of the state of the art, and which in particular dispenses with a layer of paint, but which possesses the advantageous properties, especially a matt or semi-matt appearance.

In other words, it is intended to be possible for the properties usually provided by the layer of paint to be provided by a PVC base material itself.

A further object consists in the provision of a method of applying such a coating and in indicating possible uses.

The first object is achieved by a coating for application to a substrate, comprising: high-molecular-weight, substantially ungelled polyvinyl chloride (PVC) with a K-value of more than 90, a matrix of a substantially gelled PVC material with a K-value of 60 to 80 and/or a gelled vinyl acetate/PVC copolymer with a K-value of 50-70, and at least one polymeric plasticiser.

The inventive coating thus does not require a layer of paint which shows its advantageous properties.

It has been found that vinyl acetate/PVC copolymer is particularly preferred as the matrix, since this material gels considerably better than normal PVC. As a result, in combination with the polymeric plasticiser, which usually gels very poorly, and further additives where appropriate, a basic matrix is produced which binds reasonably. On the other hand, the polymeric plasticisers, which usually gel poorly, ensure selectively that the high-molecular-weight polyvinyl chloride is not gelled and remains functionally effective virtually as rigid PVC particles.

In the context of the present invention, the expression “gelled PVC material” is used when that material is present in a properly formed glassy state. Here, the particle structures are substantially completely dissolved, the molecular network results from the largely direct formation of van der Waals binding forces between the plasticiser (preferably an ester group) and the dipole moment of the PVC via its chlorine component. An ungelled PVC, on the other hand, is fully preserved in its particle structure and actually corresponds to rigid, or unplasticised, PVC. For the coating of the invention, the matrix material should be as ideally gelled as possible in order to form the elastic soft content of the overall material and at the same time to integrate the hard content (via the high-molecular-weight ungelled polyvinyl chloride) as well as possible.

It is preferably envisaged that the high-molecular-weight, substantially ungelled polyvinyl chloride, is present in a proportion of 30-80%, preferably 50-70%, in per cent by weight based on the total amount of all the PVC materials.

In addition, it is preferred that the proportion of all the materials containing PVC in the coating is 30-70%, preferably 45-60%, in per cent by weight based on the total weight of the coating.

Additionally, the invention preferably envisages that the high-molecular-weight, substantially ungelled polyvinyl chloride, is present in the form of particles which are substantially spherical in shape, preferably with a particle size of >15 μm, preferably with a mean particle size of 20-40 μm.

In addition, it may be envisaged that the coating also contains monomeric plasticiser and optionally further additives.

It is particularly preferably contemplated that the polymeric plasticiser possesses free OH groups, which are preferably crosslinked by means of a crosslinking agent, such as a diisocyanate.

The PVC material is preferably a soft PVC.

The coating of the invention may contain not only the high-molecular-weight, substantially ungelled polyvinyl chloride, the matrix material and the polymeric plasticiser, but also optionally further additives, such as monomeric plasticisers, stabilisers, pigments, etc. The use of stabilisers enhances the light-fastness and long-term temperature stability of the coating. Without pigmenting, the substrate on which the coating has been applied can be discerned without restriction.

A second object is achieved by a method of coating a substrate wherein a coating of the invention is applied to a substrate, preferably by means of a direct coating process.

It is preferred in this connection that after the coating has been applied, no layer of paint is applied on it.

The substrate used my be any flat, compact textile structure, such as woven fabrics, nonwoven fabrics, knitted fabrics, various knitted materials, or films which have already been produced. For indirect coatings, it is possible to make temporary use of release papers as the substrate.

The invention also relates to the use of the coating of the invention for application onto a substrate for the production of automobile interior materials.

In this connection, it may be envisaged that the materials for car interiors are selected from the group consisting of material for blinds, luggage compartment covers, roller blinds for sun protection for roof, rear and side windows and windscreens, lamination films and synthetic leather.

Finally, the invention also relates to a material for car interiors comprising a coating in accordance with the present invention.

In accordance with the invention, it has surprisingly been found that a coating with the combination of components described can, in materials for use in car interiors, replace a layer of paint hitherto used in the conventional manner, and that in the process, the combination of components used can duplicate the properties usually found in the layer of paint. A coating of this kind makes it possible in particular to overcome the disadvantages of using a layer of paint as described in the introduction to the description.

An essential feature of the coating of the invention is that it comprises a high-molecular-weight, substantially ungelled polyvinyl chloride with a K-value of more than 90. The use of non-gelled PVCs is not, or only rarely, found in PVC coating materials employed hitherto, because it is traditionally assumed that the PVC content is completely or largely gelled in order to obtain a suitable profile of technical characteristics in the form, inter alia, of high tear strength and elongation at break.

In the coating of the invention, only part of the PVC with the polymeric plasticiser is gelled, whereas a major portion of the PVC contained remains ungelled, namely the high-molecular-weight polyvinyl chloride with a K-value of more than 90. With the coating of the invention. adequate matting is obtained. The coating also exhibits excellent wear resistance and resistance to chemicals, which corresponds to or even exceeds that of conventional paint polymers.

Extender-PVC or S-PVC can be used as a preferred high-molecular-weight, substantially ungelled polyvinyl chloride.

The proportion of high-molecular-weight polyvinyl chloride should preferably be selected such that the relative amount chosen enables a superficially free arrangement of the particle grain to form. It is particularly preferred for the high-molecular-weight ungelled PVC to be substantially spherical in shape so that it can be incorporated in the densest possible arrangement into the rest of the PVC basic matrix with the best possible surface adhesion for satisfactory strength parameters.

A surface of this kind with densely arranged spherical segments offers the best conditions for a paint-like surface effect with an optimum matting appearance, low sensitivity to scratches and writing, good slip properties (also slip-stick) and caking behaviour. It is particularly preferable to use extender-PVC or S-PVC types with a K-value of more than 90, preferably more than 100, preferably with a particle size of more than 15 μm. The particle size distribution is preferably narrow.

The K-value according to Fikentscher, which is also known as inherent viscosity, is determined by means of viscosity measurements of polymer solutions and is known in the art for determining the molar mass of polymers, such as PVC. Under constant measuring conditions with regard to the solvent, solvent concentration and temperature, the K-value is only dependent on the mean molar mass of the polymer analysed. In order to determine the K-value for the PVC materials of the present application, solutions were analysed in a concentration of 0.5% by weight in tetrahydrofuran (THF). The analyses were performed in accordance with DIN53 726.

It is likewise particularly preferred in accordance with the invention to use a gelled vinyl acetate/PVC copolymer as the basic matrix. The proportion of vinyl acetate in the copolymer is preferably about 3-15% by weight. The use of a copolymer of this kind leads to a particularly efficient incorporation of the ungelled PVC portion, which is confirmed when the achievable elongation at break is compared to the use of other standard pasty E-PVC or micro-S-PVC types.

In accordance with the invention, it is in principle also possible to incorporate microspheres of, e.g., polyurethanes or even of inorganic materials into the basic matrix instead of the high-molecular-weight PVC. In the process, however, considerably poorer material properties are obtained in the case of layers of material produced by means of a standard PVC coating procedure. Here, the excellent level of chemical and technical properties of the high-molecular-weight PVC described and the better capacity for incorporation into a direct PVC/PVC composite play an outstanding role. When coatings of the invention are used with substrate-reinforced materials, disadvantages with regard to the tearing force and elongation at break are no longer observed, within reasonable limits, so that it is possible here to achieve an even more specific adaptation with a view to optimising the surface properties.

The use of polymeric plasticisers ensures that there is an extremely low level of migration. Polymeric plasticisers are sufficiently well-known in the state of the art. In accordance with the invention, adipic acid polyesters are preferably used. Other polymeric plasticisers may, for example, be phthalic acid polyesters, polyester glutarates or polyester maleinates.

For polymeric plasticisers, it is known that even small amounts in a plasticiser mixture inhibit the migration tendency disproportionately. The effect here is still unclear, though a surface orientation is suspected, and it is conceivable that the familiar miscibility gaps with floating phenomena take effect.

It has also become apparent that gelled products with polymeric plasticisers exhibit excellent resistance to chemicals and solvents.

Additional benefits can be achieved with polymeric plasticisers containing free OH groups as a result of esterification with an excess of alcohol. Examples are polymers containing OH groups, such as polyols, e.g. biopolyols. With the standard isocyanate-based adhesion promoters, which are initially supposed to take effect on the surface of the fabric substrate, these plasticisers can be post-crosslinked, which again limits the capacity for migration and further improves the resistance to chemicals and solvents.

In accordance with the invention, it is likewise preferred to blend the advantageous polymeric plasticisers with monomeric plasticisers. This may be preferred, for example, if the low-temperature flexibility which is required for automotive applications cannot otherwise be achieved. Monomeric plasticisers which are particularly useful for providing low-temperature flexibility are sebaceates (DOS), adipic acid esters, trimellitic acid esters or special phosphoric acid esters (TOF). Particularly good results are obtained with sebaceate (DOS).

If the gelling temperatures to be employed when using the coating of the invention are too high, it may possibly be necessary to add special plasticisers in order lower the gelling temperature. Small amounts of sulphonic acid esters or phosphoric acid esters, such as TOF or DPO, are suitable for this purpose. The latter also contribute to flame resistance at the same time.

In the context of the present invention, the expression “special plasticisers” means those plasticisers which gel particularly quickly and/or have critical dissolution temperatures (gelling point of a standard PVC) of less than 120° C. The preferred polymeric plasticiser, on the other hand, and the preferred monomeric plasticiser have a gelling point of 155 to 165° C.

By means of a targeted selection of the proportions of high-molecular-weight and ungelled PVC, gelled PVC, vinyl acetate/PVC copolymer and the polymeric plasticisers, optionally monomeric plasticisers and optionally special plasticisers, it is possible to adjust the degree of gloss of the coating in a targeted manner.

Further features and advantages of the coating of the invention will become clear from the following detailed description with reference to preferred embodiments. It is obvious that the worked embodiments are in no way intended to limit the disclosure of the present application, but that the scope of protection of the application is defined solely by the following claims.

### ILLUSTRATIVE EMBODIMENT 1

A fabric substrate made from 1100-decitex yarn with an end spacing of 7.4/7.4 was first coated with a conventional PVC paste containing two-package adhesion promoters, with 50-80 g/m², as the adhesive coat, and gelled in a kiln channel at circulating air temperatures of 170-210° C. In the subsequent step, the top coat was likewise applied on the basis of a conventional PVC paste with a layer of approx. 250 g/m² and gelled in the kiln channel downstream at circulating air temperatures of 170-210° C. After that it was coated in-line with a conventional water-based paint based on a polyurethane/acrylate/PVC mixture. In order to dry it, a kiln channel with circulating air temperatures of 130° C. was used. The back was coated in the first coating step with the same adhesive coat as the 1st side. In the 2nd coating step, there was a difference in that a raw material composition in accordance with the invention was used as the top-coat paste as illustrated below, with a grammage of 80-150 g/m². No paint was applied.

PVC

| | |
|---|---|
| High-molecular-weight polyvinyl chloride (still substantially | 50-70% |
| ungelled in use) with a K-value of 100 (extender PVC, | |
| prepared with the suspension process), particle size | |
| (in the predominant constituent) 20-40 μm | |
| Gelled PVC with a K-value of 60-80 and/or vinyl acetate- | 30-50% |
| PVC copolymer with a K-value of 60-80 (gelling | |
| substantially completely in use) | |
| Total PVC | 100% |

Plasticiser, liquid additive materials, additives

| | |
|---|---|
| Polymeric plasticiser (adipic acid ester) e.g. Palamoll | 33-66% |
| 632 (BASF) | |
| sebaceate ester (DOS) e.g. Edenol 888 | 20-40% |
| phosphoric acid ester e.g. Disflamoll DPO | 0-7% |
| sulphonic acid ester e.g. Mesamoll 2 | 0-7% |
| rheology additives | 0-1.5% |
| slip additives | 0-2% |
| stabilisers | 1.5-5% |
| colour batch - grey - 40% | 5-10% |
| adhesion promoter 1, various polyols e.g. TN/N | 0-5% |
| adhesion promoter 2, prepolymerised hexamethylene | 0-5% |
| di-isocyanate, e.g. Desmodur N | |
| alternatively single-package adhesion promoter based on | 0-10% |
| trimerised diphenyl methane di-isocyanate | |
| Total plasticiser, liquid additive materials, additives | 100% |
| The proportion of the total PVC in the paste is | 47-57% |

All the figures given in the illustrative embodiments are in per cent by weight. Apart from the components which are essential to the invention (high-molecular-weight, substantially ungelled PVC, gelled PVC matrix and polymeric plasticiser), a wide range of further components, such as monomeric plasticisers, liquid additive materials or additives in extremely varied amounts, may optionally be incorporated.

The paint application was dispensed with. The coating was applied conventionally as a direct fabric coating by means of a doctor blade and gelled in a kiln channel at a circulating air temperature of 180-200° C. and an operating speed of 10-40 m/min. In this processing step, the high-molecular-weight PVC is not gelled, because it might otherwise lose its function as a rigid PVC. The final processing step in the production of material in this and all the following embodiments is the introduction of graining by embossing with a pressure-loaded chilled embossing roller into the front side, the surface of which is heated by contact and radiant heat to 140-180° C. For special applications, it is, however, also possible to produce unembossed versions.

### Result:

The result was a surface appearance which was visually indistinguishable from a high-matt paint application. For the gloss (60% reflection), a value of 0.9 was determined. The sensitivity to writing was surprisingly found to be minimal. Since no grid-like coating structures had formed, the result was a completely homogeneous surface impression. Any unevenness in the fabric was likewise unable to cause any impairment in this connection, even though the layer applied was already reduced by approx. 30%.

When the surface was tested with the standard test media—benzine, isopropanol, spirit—using a Crockmeter for example, no visible impairments and no abrasion of the type often found with painted surfaces were discovered. Even when the number of rubbing cycles was doubled, nothing changed, so that better load resistance can be assumed. Even when abraded matter was created by the use of force, there were no visible signs of the typical shininess that appears when a thin matt-painted surface is destroyed. The typical test of determining the blocking point (50 N load on 25 cm²) did not reveal any measurable blocking with a material pairing of 2 reverse sides produced in this way and a load duration of 24 h at 70/90/100° C. respectively. When the materials were paired against a front side coated a conventional water-based paint, clearly perceptible blocking occurred at the test temperature of 100° C. The material pairing with two front sides coated with the same water-based paint already exhibited this clearly perceptible blocking at 90° C.

The material formed is very often processed to produce partial combinations with HF welding, PVC is a material that offers very positive conditions for this. It became apparent that the welding power induced by the absence of a layer of paint could be reduced by approx. 30%. When the material underwent further processing in the form of embossing, no shiny patches could be seen on the paint-free reverse side.

### ILLUSTRATIVE EMBODIMENT 2

The front was formed analogously to illustrative embodiment 1. Since it was realised that the caliper of the back could be made considerably thinner, because no leveling was needed for a paint application to carry out its functions reliably, the raw material composition described, which was in accordance with the invention, was applied with only one coat in a grammage of 80-150 g/m². The application of the top coat and the paint was dispensed with.

### Result:

All the main appearance criteria of illustrative embodiment 1 remained unchanged. When, for example, a 4% single-package adhesion promoter was used, the adhesion of the PVC coat on the fabric substrate which is usually found for these materials was obtained. When the back was treated with a very thin layer thickness and a full range of functions, considerably less sensitivity with regard to blister formation was observed when embossing the front, which made it possible to use higher temperatures for greater accuracy in reproducing complex graining, greater thermal graining resistance or a faster heating speed for more rapid embossing.

### ILLUSTRATIVE EMBODIMENT 3

The front was formed in the first coat as in illustrative embodiment 1. For the formation of the top coat, a difference was that the raw material composition of the invention was used with a layer thickness of approx. 250 g/m². The in-line paint application was dispensed with. The back was processed analogously to illustrative embodiment 1.

### Result:

The positive aspects of the surface appearance of illustrative embodiments 1 and 2 remained unchanged and could also be transferred to the front. A particularly striking result was the complete absence of grid-like coating structures, which also reduces the risk of moiré structures considerably. The embossing process was completely unproblematic, with a substantial reduction in the amount of energy introduced. No deposits could be seen on the embossing rolls. Nor were any shiny patches visible on the surface.

### ILLUSTRATIVE EMBODIMENT 4

The front was processed in accordance with illustrative embodiment 3, and the back in accordance with illustrative embodiment 2.

### Result:

Compared to illustrative embodiment 3, there was a further improvement in the embossing behaviour, while still exploiting the property advantages of illustrative embodiment 2.

### ILLUSTRATIVE EMBODIMENT 5

The front was treated exclusively with an application of the combination of raw materials of the invention with a grammage of 150-350 g/m². The paint application was dispensed with. The back was likewise treated with only one coating, and the layer of paint was dispensed with in line with illustrative embodiment 2.

### Result:

With only 2 applications of paste, it was possible to produce a fully functioning PVC material for the intended applications. Finishing properties, such as the embossing behaviour and the welding behaviour proved clearly superior to conventional, painted material. In the resistance to the standard stress media, the material produced in accordance with the invention likewise proved distinctly better. As had been expected, emission analyses revealed very low fogging, and in a highly sensitive emission test in accordance with VDA 278, no solvents at all could be detected. All the tests regarding light-fastness and long-term storage in heat, in accordance with the usual standards applicable to cars, were passed. In the test on blocking behaviour, all the possible material pairings of the respective sides exhibited no measurable blocking at a test temperature of 100° C.

### ILLUSTRATIVE EMBODIMENT 6

For the material in accordance with illustrative embodiment 5, a polymeric adipic acid ester was used in the combination of raw materials of the invention, which is intended for polyurethane applications, but which is comparable in material terms to the polymeric plasticisers otherwise used—though it includes defined terminal OH groups. As the adhesion promoter and crosslinker, 8% single-package adhesion promoter was used.

### Result:

In some abrasion tests, and also in terms of patch and dirt-resistance, advantages were apparent.

The adipic acid ester used here contains a precisely adjusted proportion of terminal OH groups, which can functionally generate reproducible crosslinking with an isocyanate. Furthermore, the choice of raw materials in illustrative embodiment 6 means that the proportion of non-esterified polyols, which cause chain breaks during crosslinking, is kept to a minimum.

### Illustrative embodiment 7

During preparation of the material in accordance with illustrative embodiment 5, 1% finely dispersed polypropylene powder was added to the combination of raw materials of the invention in order to improve the slip behaviour.

### ILLUSTRATIVE EMBODIMENT 8

A substrate-free lamination film was produced by coating a conventional PVC paste with a layer grammage of 250 g/m² onto a release paper. Gelling occurred in a kiln channel at a circulating air temperature of 190° C. In the subsequent coating step, the combination of raw materials of the invention was applied to form the front, likewise with 250 g/m², and gelled in a kiln channel at a circulating air temperature of 220° C. The speed of passage was approx. 30 m/min.

### Result:

On the front, it was possible to adjust the paint functions reliably; since there was no pass through a printing press, frozen tensile stresses were avoided; an advantage was that during the subsequent processing, only minimal shrinkage could be found. The back, however, was unpainted, and it was not given the coating of the invention, which duplicate a paint function.

### ILLUSTRATIVE EMBODIMENT 9

A substrate-free lamination film was produced in accordance with illustrative embodiment 8, applying the combination of raw materials of the invention in both coats.

### Result:

The paint function could only be reliably adjusted on the top side. On the underside, the direct contact with a layer of paper meant that the projection of the proportions of the ungelled high-molecular-weight PVC was distinctly suppressed, which immediately made its effect felt in a higher degree of shine. Paint functions could only be used subject to major limitations. If these limitations are acceptable, however, a particularly low-shrink material can be used. In the case of substrate-free materials, moreover, the reduced tear strength and elongation at break have to be taken into account.

In contrast to illustrative embodiments 1 to 8, which describe a direct coating process, and in which, with the quantities specified, the surface is always formed with a surface profile, illustrative embodiment 9 concerns an indirect coating process, which means that while the top side is also formed with a surface profile here too, with the quantities specified, it is nevertheless the case that with the indirect coating process on paper, the side facing the paper is normally the surface side of the material, which is the one used, but the desired surface profiling on that side is very much suppressed. Because of the gelled, even molten basic matrix, it is substantially the case that a smooth and functional paper image is created, which impairs the formation of the intended paint functions, while the surface which is actually unused, and which is usually coated over with the second optional further layer, forms the desired surface of the coating of the invention. Finally, according to illustrative embodiment 9, it is possible to produce synthetic leather by means of further steps. It has been found that by using rough release papers, especially if there is a correlation between the surface roughness and the particle dimensions, the impairment of the paint function described can be suppressed.

The features of the invention disclosed in the above description and in the claims can be essential to implementing the invention in its various embodiments both individually and in any combination.

1. A coating for application to a substrate, comprising:
high-molecular-weight, substantially ungelled polyvinyl chloride (PVC) with a K-value of more than 90,
a matrix of a substantially gelled PVC material with a K-value of 60 to 80 and/or a gelled vinyl acetate/PVC copolymer with a K-value of 50 to 70, and
at least one polymeric plasticiser.

2. The coating as claimed in claim 1, characterised in that the high-molecular-weight, substantially ungelled polyvinyl chloride is present in an amount of 30-80%, in per cent by weight, based on the total amount of all the PVC materials.

3. The coating as claimed in claim 1, characterised in that the amount of all the PVC-containing materials in the coating is 30-70%, preferably 35-70%, preferably 45-60%, in per cent by weight, based on the total weight of the coating.

4. The coating as claimed in claim 1, characterised in that the high-molecular-weight, substantially ungelled polyvinyl chloride is present in particles which are substantially spherical in shape, preferably with a particle size of >15 μm, preferably with a mean particle size of 20-40 μm.

5. The coating as claimed in claim 1, characterised in that the coating further contains monomeric plasticiser and optionally further additives.

6. The coating as claimed in claim 1, characterised in that the polymeric plasticiser possesses free OH groups, which are preferably crosslinked by means of a crosslinking agent, such as a diisocyanate.

7. A method of coating a substrate, characterised in that a coating as claimed in claim 1 is applied to a substrate, preferably by means of a direct coating process.

8. The method as claimed in claim 7, characterised in that after the coating has been applied, no layer of paint is applied on it.

9. Use of the coating as claimed in claim 1 for application onto a substrate for the production of automobile interior materials.

10. The use as claimed in claim 9, characterised in that the materials for car interiors are selected from the group consisting of material for blinds, luggage compartment covers, roller blinds for sun protection for roof, rear and side windows and windscreens, lamination films and synthetic leather.

11. A material for car interiors comprising a coating as claimed in claim 1.
